(19) United States
(12) Patent Application Publication
(10) Pub. No.: US 2013/0219886 A1
(43) Pub. Date: Aug. 29, 2013

(54) EXHAUST GAS RECIRCULATION ARRANGEMENT WITH CONDENSATE DISCHARGE

(71) Applicant: DAIMLER AG, (US)

(72) Inventors: Thomas Koch, Boeblingen (DE); Johannes Ritzinger, Stuttgart (DE)

(73) Assignee: DAIMLER AG, Stuttgart (DE)

(21) Appl. No.: 13/844,992

(22) Filed: Mar. 17, 2013

Related U.S. Application Data
(63) Continuation-in-part of application No. PCT/EP2011/004692, filed on Sep. 20, 2011.

(30) Foreign Application Priority Data
Sep. 20, 2011 (DE) 10 2010 048 465.2

(51) Int. Cl. F02M 25/07

(52) U.S. Cl. CPC F02M 25/07
USPC 60/605.2

(57) ABSTRACT

In an exhaust gas recirculation arrangement in which condensate is discharged from an exhaust gas recirculation path of an internal combustion engine, in particular of a motor vehicle, wherein, due to a pressure difference between a condensate collection region arranged in the EGR path and a condensate discharge region, collected condensate is discharged at least partially from the condensate collection region into the condensate discharge region, when the pressure level prevalent in the condensate collection region is greater than in the condensate discharge region in a secure manner and with low environmental impact.

This is a Continuation-In-Part application of pending international patent application PCT/EP2011/004692 filed Sep. 20, 2011 and claiming the priority of German patent application 10 2010 048 465.2 filed Oct. 14, 2010.

### BACKGROUND OF THE INVENTION

The present invention relates to an exhaust gas recirculation arrangement for discharging condensate from an EGR path (EGR—exhaust gas recirculation) of an internal combustion engine. The invention also relates to an exhaust gas unit with such an EGR arrangement.

In internal combustion engines with exhaust gas recirculation (EGR), a specific proportion of the exhaust gas is fed back to the combustion engine via an EGR path. Under specific conditions, condensate can be discharged from the exhaust gas or from an exhaust gas/air mixture in the EGR path. The condensate can lead to sooting and corrosion of the components in the EGR path. It is thus desirable to remove the condensate from the EGR path as quickly and completely as possible or to suppress the formation of condensate.

In WO 2006/087062 A1 , in the case of a low-pressure EGR, the formation of condensate is prevented by a charge air cooler being in the form of a down-draft cooler, such that potentially occurring condensate collects at the lowest point of the upright charge air cooler and can be subsequently discharged, In the case of a high-pressure EGR system, at least one EGR cooler is preferably provided in the exhaust gas flow, with the final EGR cooler being such a down-draft cooler so that the potentially formed condensate can collect at the lowest point of the EGR cooler.

A charge air cooler with condensate discharge is described in EP 2 161 430 A1 The EGR device is a low-pressure EGR. Potentially occurring condensate can be collected in the charge air cooler at the lowest point of the charge air cooler. The charge air cooler is equipped with a condensate discharge opening, which is s connected to a fresh air path fluidically via a condensate discharge line. Here, the condensate inlet point is arranged after the charge air cooler in the chair air flow direction, The condensate discharge opening can be sealed by means of a sealing element. Thus, potentially occurring condensate can be deferred by the charge air cooler, if insertion of the condensate into the fresh air path is unfavorable due to the respective operating condition. Should inserting the condensate not be problematical, the sealing element can be opened and the condensate can be fed into the fresh air path.

The exhaust gas unit of the internal combustion engine of WO 2009/048408 A1 is equipped with a high-pressure EGR. Here, one or two first EGR cooler(s) and a final EGR cooler are arranged in the EGR path. The exhaust gas in the EGR path region of the first cooler(s) can be circulated by means of a four-way valve. Due to the longer contact time of the exhaust gas with the first EGR cooler(s), air increased amount of condensate can be discharged from the circulated exhaust gas. The first EGR cooler(s) can at least partially be purified of impurities by means of the discharged condensate.

An internal combustion engine with a high-pressure EGR is described in WO 2009/072963A1. Two EGR coolers are arranged in the EGR path of the EGR system. Here, in the second EGR cooler, any condensate arising can be discharged in the EGR path before the first EGR cooler via an EGR discharge line. Here the EGR cooler is air-cooled and possesses a condensate collection region, which is connected to the EGT path before the first EGT cooler or to the first EGR cooler in a fluidically conductive manner via the condensate discharge line, For the removal of the condensate formed from the EGR path, a pump is arranged in the condensate discharge line, with which the condensate can be transported to the EGR path in case of counter-pressure. Supplying the condensate by means of a pump in the EGR path is, however, constructively complex and, if further components are additionally present, these can be damaged due to the aggressive, corrosive atmosphere of the recirculated exhaust gas and their function can be compromised.

A charged combustion engine having at least one cylinder is know from WO 2006/087062 A1, wherein, with the aid of a compressor, pre-compressed fuel/air mixture is compressed and combusted, wherein exhaust gas is present, which is discharged from the cylinder and released in a turbine. A part of the exhaust gas discharged from the cylinder is recirculated via a high-pressure recirculation before it is released in the turbine, which is equipped with an exhaust gas cooling device which comprises at least two cooling circuits, which are guided through heat transfer blocks and which are connected behind one another in the flow direction of the exhaust gas. In order to create a combustion engine that can be produced cost-effectively and that has a high level of efficiency, the heat exchanger block, which is arranged at the furthest point downstream in the flow direction of the exhaust gas, is arranged upright, such that the heat exchanger block is flowed through by the exhaust gas parallel to the line of application of gravitational force from above to below or from below to above, wherein a condensate collection and/or discharge device is provided at the lower end of the heat exchanger block.

Further combustion engines are known from JP 2008088817A, JP 07269417 A and JP 20000027715A.

It is the principal object of the present invention to provide an improved arrangement for discharging condensate from an EGR system of an internal combustion engine, which is characterized in particular by a simplified, less vulnerable condensate transport into the respective condensate discharge region.

### SUMMARY OF THE INVENTION

In an exhaust gas recirculation arrangement in which condensate is discharged from an exhaust gas recirculation path of an internal combustion engine, in particular of a motor vehicle, wherein, due to a pressure difference between a condensate collection region arranged in the EGR path and a condensate discharge region, collected condensate is discharged at least partially from the condensate collection region into the condensate discharge region, when the pressure level prevalent in the condensate collection region is greater than in the condensate discharge region in a secure manner and with low environmental impact.

By exploiting the pressure difference between the condensate collection region and the condensate discharge region, the condensate can be advantageously discharged from the condensate collection region in this simple manner. This way of discharging condensate from an EGR path can also be applied for charged petrol engines and even for charged diesel engines. Here, the respective combustion engines can be equipped with a high-pressure and/or low-pressure EGR. EGR path is understood as any line region, including the components arranged therein and those flowed through by the recirculated exhaust gas, by means of which the recirculated exhaust gas is fed to the fresh air path, and the section of the fresh air path that is flowed through by the recirculated exhaust gas. As a consequence of this, the EGR path is arranged between a point of divergence of the exhaust gas from the exhaust gas path and the combustion engine. The exhaust gas path is, as a consequence, the line region through which exhaust gas flows. The fresh air path is any line region via which fresh air is fed to the internal combustion engine, wherein at least a section of the line region can also be added to the EGR path.

A high-pressure EGR is understood to be an EGR device wherein the inlet position is arranged after a compressor of a charging device. Thus, the recirculated exhaust gas is discharged into a high-pressure region. A low-pressure EGR is accordingly an EGR device wherein the inlet position for the recirculated exhaust gas is arranged before a compressor of a charging device. Thus, in a low-pressure EGR, the recirculated exhaust gas is discharged into a low-pressure region. The combination of low-pressure EGR and high-pressure EGR is possible for an EGR device, as well as the individual application of high-pressure or low-pressure EGR being conceivable. The condensate discharged in a respective heat exchanger mainly consists of water and sulphur dioxide, which react in conjunction with the water to form sulphurous acid or sulphuric acid or a mixture thereof. Furthermore, nitrogen oxide or nitrogen oxide acids can occur in the condensate, as well as combustion residues. Above all, for sulphur-containing fuel, it is problematical to have sulphuric acid or sulphurous acid or a mixture of both acids present in the condensate. Therefore, primarily highly concentrated sulphuric acid is discharged as the condensate, which can only be significantly diluted once the dew-point of the water steam has been reached. Furthermore, a concentration of the sulphurous or sulphuric acid occurs in the condensate instead of the condensate being evaporated, if attempted. Thus, the condensate can only be re-evaporated at very high temperatures. As a consequence, it is advantageous to either completely prevent condensate formation or discharge the condensate, wherein, due to a complete removal of the condensate formed, the recirculated exhaust gas is, additionally, less aggressive and corrosive and the exhaust gas emission levels are improved.

The discharge of condensate from the condensate collection region can, according to a preferred embodiment of the invention, be controlled by means of a sealing element. Thus, even when a higher pressure level is prevalent in the condensate collection region than in the condensate discharge region, the sealing or valve element can be opened, such that the condensate is discharged from the condensate collection region due to the pressure difference. It is thus preferred for the sealing element to be opened when the pressure in the condensate collection region is 20%, preferably 40% or 60% greater than the pressure in the condensate discharge region.

Likewise, the sealing element is preferably opened temporarily. This opening is carried out so quickly that the temporarily occurring pressure decrease in the EGR path only has an insignificant effect with respect to a charging pressure and/or lambda regulation. The sealing element can be an electronically activatable valve, as a pressure-controlled valve or the like. The opening of the sealing element can, at least in one partial load region, is carried out in such a way that it simultaneously serves to discharge the collected condensate and de-throttle the combustion engine. Consequently, if necessary, an overrun air recirculation valve can be replaced to prevent a pump of the compressor of a charging device from undergoing sudden load variations, as is currently used in gasoline engines. Furthermore, such an opening of the sealing element can provide dynamic advantages for simultaneous condensate discharge and combustion engine de-throttling in a partial load region, since the charging device starts at a higher level of rotational speed.

A further general concept of the invention is an EGR arrangement, in particular an internal combustion engine with a charging device comprising a turbine and a compressor. As a fundamental component, the EGR device possesses at least one condensate discharge device for discharging condensate from an EGR path, wherein the condensate discharge device has a condensate collection region arranged in the EGR path and a sealing element arranged before or after a discharge opening. The EGR device is, however, designed in such a way that, due to a pressure difference between the condensate collection region and a condensate discharge region when the sealing element is opened, condensate collected from the condensate collection region is discharged into the condensate discharge region.

Thus, discharged condensate in the EGR path can be collected by means of the condensate discharge device and removed from the EGR path in a targeted manner by opening the sealing element. Thus, by means of the condensate discharge device, the aggressive, corrosive condensate can at least partially be removed from the recirculated exhaust gas, such that the components arranged after the condensate discharge device are subject to a lower corrosive stress in the EGR path, which, for these components, leads to greater durability and to fewer malfunctions. It is preferable to remove the condensate as fully as possible.

Also, the of the condensate discharge device is arranged in the exhaust gas flow direction after a heat exchanger. The condensate discharge device can also be designed integrally with the heat exchanger. The heat exchanger can thus be an EGR cooler and/or a charge air cooler. The condensate discharge device is arranged after the charge air cooler and before the restrictor element. In this case, by controlling the restrictor element in the region of the condensate discharge device, a higher pressure can be generated in a simple manner, so that, by activating the restrictor element, a pressure difference between the condensate collection region and the condensate discharge region can be generated. With this arrangement of the condensate discharge device including a valve element, de-throttling of the internal combustion engine in a partial load range is also advantageously possible.

Furthermore, a control device can be provided, which controls the opening and closing of the valve or sealing element. Thus the control device can be designed integrally with the engine control or it can be a separate unit, which, if necessary, communicates with the engine control. At least one condensate discharge region can be the EGR path before the compressor, an exhaust gas path after the turbine, the exhaust gas path after an exhaust gas catalyst and/or an atmosphere located outside of the EGR device. Thus, the condensate can be fed back into the fresh air path. It is thus preferable to choose to discharge before the compressor of the charging device, since a lower pressure is prevalent in this fresh air path. Furthermore, it is also possible to discharge the condensate into the exhaust gas path. Therefore, the condensate can be discharged into the exhaust gas path after the turbine of the charging device or after the exhaust gas catalyst. It is preferable to discharge the condensate into the exhaust gas path in the exhaust gas flow direction downstream of the point of divergence of the EGR path, since, in this case, the condensate that is discharged into the exhaust gas path can no longer reach the EGR path and thus it is impossible to concentrate the condensate in the recirculated exhaust gas. To discharge the condensate, the condensate collection region can be connected fluidically to the condensate discharge region via a condensate discharge line. The condensate discharge device can be arranged in the exhaust gas flow direction before a restrictor element in order to limit the air supply to the combustion engine. Furthermore, the condensate discharge device can be arranged in the exhaust gas flow direction after a compressor of the charging device.

A tangential deviation of the respective heat exchanger, in particular the charge air cooler, is preferred, such that the condensate formed in the respective heat exchanger can flow quickly into the condensate discharge device. A water separator can also be arranged in the exhaust gas flow direction before the condensate discharge device. This water separator can also be arranged in the exhaust gas flow direction after the respective heat exchanger. Here, the use of a water separator, together with an EGR cooler, is preferred. By using the water separator, the condensate can be discharged from the exhaust gas in a more complete manner. It is also conceivable to design the respective heat exchanger with a water separator integrated therein.

An exhaust gas system that is equipped with such an EGR device is characterized by fundamentally lower component stress in the EGR path.

Further important features and advantages of the invention will become apparent from the following description with reference to the accompanying drawings.

It is understood that the features that are cited above and are still to be illustrated below can not only be used in the respectively specified combination, but also in other combinations or individually, without exceeding the scope of the present invention.

The drawings show exemplary embodiments of the invention which are illustrated in greater detail in the description below, wherein the same reference numerals refer to the same or similar or functionally identical components.

### BRIEF DESCRIPTION OF THE DRAWINGS

FIG. 1: shows an internal combustion engine with an exhaust gas system according to the invention, which has a low-pressure EGR with condensate discharge into the exhaust gas duct,

FIG. 2: shows an internal combustion engine with an exhaust gas system, which has a low-pressure EGR with condensate discharge into the EGR duct,

FIG. 3: shows an internal combustion engine with the exhaust gas system, which has a low-pressure EGR with condensate discharge into the atmosphere, and

FIG. 4: shows a heat exchanger with a condensate discharge device arranged downstream in the exhaust gas flow direction.

### DESCRIPTION OF EXEMPLARY EMBODIMENTS

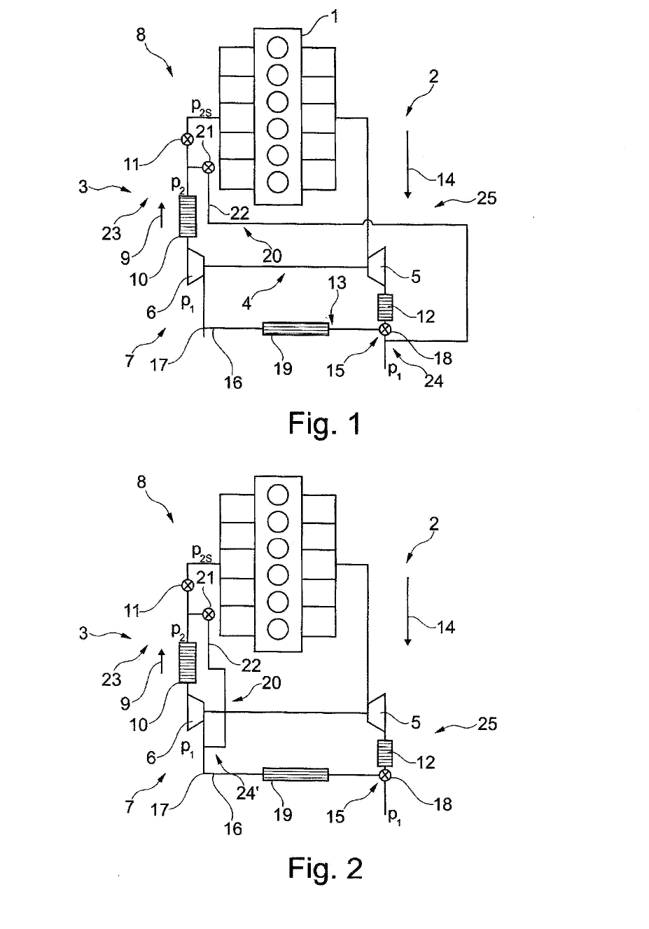

An internal combustion engine 1 as shown in FIG. 1 is equipped with an exhaust gas path 2 and a fresh air supply system 3, as well as a charging device 4. A turbine 5 of the charging device 4 is driven by means of the exhaust gas flowing in the exhaust gas path 2. The fluids flowing in the fresh air path 3 are compressed by means of a compressor 6 of the charging device 4. Thus, the fresh air path 3 is divided into a low-pressure region 7 and a high-pressure region 8. The low-pressure region 7 is arranged before the compressor 6 in the fresh air flow direction 9 and the high-pressure region 8 is arranged after the compressor 6. Likewise, a heat exchanger 10 in the form of a charge air cooler is arranged in the fresh air path 3 downstream of the compressor 6 and a restrictor element 11, with which the fresh air supply to the internal combustion engine 1 can be limited, is arranged downstream of the heat exchanger 10 which is in the form of a charge air cooler. A pressure p₁ is prevalent in the fresh air path 3 in the low-pressure region 7, a pressure p₂ is present in the high-pressure region 8 before the restrictor element 11 and a pressure p₂ₛ exists after the restrictor element 11. During operation of the combustion engine 1, the pressure p₂ is thus greater than the pressure p₂ₛ and also greater than the pressure p₁.

A catalytic converter 12 may be arranged in the exhaust gas path 2. It is typical, in a low-pressure EGR 13 shown in FIG. 1, for exhaust gas to be partially removed at a point of divergence 15 downstream of the catalytic converter 12 and to be discharged into the fresh air path 3 at a point of discharge 17 via an EGR path 16. Thus, in the low-pressure EGR 13, the point of discharge 17 is located upstream of the compressor 6, such that the recirculated exhaust gas is discharged into the low-pressure region 7 of the fresh air path 3. Additionally, an EGR valve 18 can be arranged at the point of divergence 15, as is shown in FIG. 1, or in the EGR path 16, with which the amount of recirculated exhaust gas can be controlled/regulated. Furthermore, at least one heat exchanger 19 in the form of an EGR cooler can be arranged in the EGR path 16, with which the recirculated exhaust gas can be cooled.

A condensate discharge arrangement 20 may be in the form of a charge air cooler provided in the fresh air path 3 downstream of the heat exchanger 10. The condensate discharge arrangement 20 is equipped with a blocking element 21 and has a condensate discharge line 22. The blocking element 21 can be a restrictor element, a valve or the like. The condensate discharge from a condensate collection region 23 to a condensate discharge region 24 can be controlled by means of the blocking element 21. Here, the condensate collection region 23 is in communication with the condensate discharge region 24 via the condensate discharge line 22. In the embodiment shown in FIG. 1, the condensate discharge region 24 is arranged in the exhaust gas path 2 downstream of the catalytic converter 12 in the exhaust gas flow direction 14 and downstream of the EGR valve 18 and downstream of the point of divergence 15. Thus the condensate is discharged into the exhaust gas path 2 in such a way that it is no longer able to return to at the EGR path 16 and there is thus no concentration of the condensate in the EGR path 16.

In the embodiment shown in FIG. 2, the condensate formed is discharged into the condensate discharge region 24′ via the condensate discharge line 22. Here the condensate discharge region 24′ is located upstream of the compressor 6 in the fresh air flow direction 9.

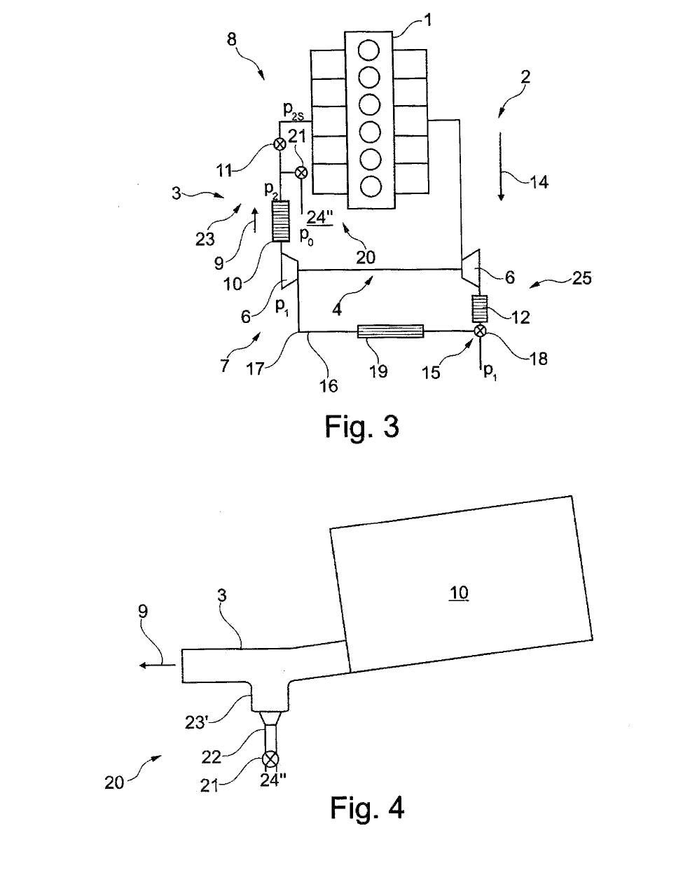

According to FIG. 3, the condensate can also be discharged into the atmosphere. Consequently, the condensate discharge region 24″ is the atmosphere or the environment, wherein, in this case, the condensate must be discharged against the atmospheric ambient pressure or against the regular pressure p₀. As a consequence of this, the pressure p₂ must be greater than the ambient pressure p₀, so that the condensate can be discharged into the condensate discharge region 24″. In this case, it must be considered that the condensate should, if necessary, be diluted or neutralized, due to its aggressiveness and corrosiveness.

A condensate discharge device 20 shown in FIG. 4 is arranged downstream of the heat exchanger 10 in the fresh air flow direction 9. Here the heat exchanger 10 is preferably tilted, such that condensate that is potentially formed in the heat exchanger 10 can flow in a simple manner to the condensate discharge device 20. Consequently, the condensate discharge device 20 is preferably arranged at the lowest point with respect to the fresh air path 3 and the heat exchanger 10. Here the condensate discharge device 20 can have, in addition to the condensate discharge line 22 and the blocking element 21, a condensate collection region 23′, which is in the form of a collecting basin, a tubular indentation, tubular recess or the like. This simplifies the collection of the condensate in the condensate collection region 23′, so that condensate can be supplied to the condensate collection region 23′ from where the condensate can be discharged when there is a suitable pressure difference between the condensate collection region 23′ and the condensate discharge region 24″.

Thus, an EGR device 25 can have, as an essential component, the EGR path 16, at least one heat exchanger 19 designed as an EGR cooler and at least one blocking element 21. Here the blocking element 21 can be a throttle valve. As a further essential component, the EGR device 25 possesses the condensate discharge device 20. This condensate discharge device 20 may include the condensate collection region 23 and a condensate discharge line 22.

What is claimed is:

1. An exhaust gas recirculation (EGR) arrangement (25) of an internal combustion engine (1), comprising:
a charging system (4) including a turbine (5) and a compressor (6) connected to the turbine so as to be driven thereby,
at least one condensate discharge device (20) for the discharge of condensate from an EGR path (16) of the EGR device (25),
the condensate discharge device (20) having a condensate collection region (23) arranged in the EGR path (16) and a blocking element (21),
the EGR device (25) being adapted due to a pressure difference between the condensate collection region (23) and a condensate discharge region (24, 24′, 24″), to discharge collected condensate from the condensate collection region (23) into the condensate discharge region (24, 24′, 24″) when the blocking element (21) is opened
the EGR device (25) being a low pressure EGR device (13) with
a heat exchanger (10) in the form of a charge air cooler being arranged in the fresh air path (3) downstream of the compressor (6) and a restrictor element (11), with which the fresh air supply to the combustion engine (1) can be limited being arranged upstream of the internal combustion engine,
a catalytic converter (12) arranged in an exhaust gas path (2) wherein exhaust gas is partially removed downstream of the catalyst (12) at a point of divergence (15) and is conducted via an EGR path (16) into the fresh air path (3) at a discharge point (17),
an EGR valve (18) arranged at the point of divergence (15) for controlling the amount of recirculated exhaust gas, and
at least one heat exchanger (19) in the form of an EGR cooler arranged in the EGR path (16).

2. The EGR arrangement according to claim 1, wherein a control device is provided for controlling the opening and closing of the blocking element (21).

3. The EGR arrangement according to claim 1, wherein at least one condensate discharge region (24, 24′, 24″) is selected from the group comprising: the EGR path (16) before the compressor (6), an exhaust gas path (2) after the turbine, the exhaust gas path (2) after the exhaust gas catalytic converter (12), and the ambient outside of the EGR device (25).

4. The EGR arrangement according to claim 3, wherein the condensate collection region (23) is in communication with the condensate discharge region (24, 24′, 24″) via a condensate discharge line (22).

5. The EGR device according to claim 1, wherein the condensate discharge device (20) is an integral part of the heat exchanger (10, 19).

6. The EGR device according to claim 1, wherein a water separator is arranged upstream of the condensate discharge device (20).

7. An exhaust gas handling system for a motor vehicle, having an internal combustion engine (1) with an EGR arrangement (25) according to claim 1.
